(19) United States
(12) Patent Application Publication
(10) Pub. No.: US 2025/0269395 A1
(43) Pub. Date: Aug. 28, 2025

(54) FILTERED SPRAY HEAD ASSEMBLY

(71) Applicant: Kohler Co., Kohler, WI (US)

(72) Inventors: Michael Soetaert, Sheboygan, WI (US); Evan Yee, Grafton, WI (US)

(73) Assignee: Kohler Co., Kohler, WI (US)

(21) Appl. No.: 19/053,106

(22) Filed: Feb. 13, 2025

Related U.S. Application Data
(63) Continuation of application No. 29/929,689, filed on Feb. 23, 2024.
(60) Provisional application No. 63/557,040, filed on Feb. 23, 2024.

(51) Int. Cl. B05B 15/40; B05B 1/18; E03C 1/04

(52) U.S. Cl. CPC B05B 15/40; B05B 1/18; E03C 1/0408; E03C 2201/40

(57) ABSTRACT

A spray head assembly includes an inlet assembly configured to receive a fluid, a body fluidly coupled with the inlet assembly, a head portion fluidly removably coupled with the body, and a filter assembly. The head portion includes a plurality of nozzles configured to discharge fluid from the spray head assembly. The body and the head portion define an interior chamber. The filter assembly is configured to filter the fluid supplied from the inlet assembly to the head portion. The filter assembly is configured to be received within the interior chamber.

### CROSS-REFERENCE TO RELATED APPLICATIONS

This application claims the benefit of and priority to U.S. Provisional Patent Application No. 63/557,040, filed Feb. 23, 2024, which is incorporated herein by reference in its entirety.

### BACKGROUND

The present disclosure relates generally to water delivery devices, such as showerhead assemblies.

### SUMMARY

One embodiment of the present disclosure relates to a showerhead assembly configured to filter a fluid (e.g., water) flowing therethrough.

One embodiment of the present disclosure relates to a spray head assembly. The spray head assembly includes an inlet assembly configured to receive a fluid, a body fluidly coupled with the inlet assembly, a head portion fluidly removably coupled with the body, and a filter assembly. The head portion includes a plurality of nozzles configured to discharge fluid from the spray head assembly. The body and the head portion define an interior chamber. The filter assembly is configured to filter the fluid supplied from the inlet assembly to the head portion. The filter assembly is configured to be received within the interior chamber. In some embodiments, separating the body and the head portion from each other facilitates providing access to the interior chamber to replace the filter assembly.

Another embodiment of the present disclosure relates to a spray head assembly. The spray head assembly includes an inlet assembly configured to receive a fluid, a body fluidly coupled with the inlet assembly, a head portion fluidly removably coupled with the body, the head portion including a plurality of nozzles configured to discharge the fluid from the spray head assembly, the body and the head portion defining an interior chamber, a filter housing defining a filter chamber and configured to be received within the interior chamber, and a filter assembly configured to filter the fluid supplied from the inlet assembly to the head portion, the filter assembly configured to be received within the filter chamber. The spray head assembly is configurable both as (i) a first spray head assembly including the body and the head portion defining a first shape configured to receive the filter housing and (ii) a second spray head assembly including the body and the head portion defining a second shape configured to receive the filter housing. The second shape is different than the first shape.

Still another embodiment of the present disclosure relates to a spray head assembly. The spray head assembly includes an inlet assembly configured to receive a fluid, a body fluidly coupled with the inlet assembly, the body including a connector flange, a head portion fluidly coupled with the body, the head portion including a plurality of nozzles configured to discharge the fluid from the spray head assembly, a filter housing defining a filter chamber, the filter housing including a first sidewall, a top wall configured to couple to the connector flange to couple the first sidewall with the body, and a second sidewall configured to couple to the head portion and overlap with at least a portion of the first sidewall, and a filter assembly configured to filter the fluid supplied from the inlet assembly to the head portion, the filter assembly configured to be received within the filter chamber of the filter housing.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a bottom perspective view of a spray head assembly, according to an embodiment;

FIG. 2 is a top perspective view of the spray head assembly of FIG. 1;

FIG. 3 is a front view of the spray head assembly of FIG. 1;

FIG. 4 is a side view of the spray head assembly of FIG. 1;

FIG. 5 is a top view of the spray head assembly of FIG. 1;

FIG. 6 is a bottom view of the spray head assembly of FIG. 1;

FIG. 7 is a bottom perspective view of a spray head assembly, according to another embodiment;

FIG. 8 is a top perspective view of the spray head assembly of FIG. 7;

FIG. 9 is a front view of the spray head assembly of FIG. 7;

FIG. 10 is a side view of the spray head assembly of FIG. 7;

FIG. 11 is a top view of the spray head assembly of FIG. 7;

FIG. 12 is a bottom view of the spray head assembly of FIG. 7;

FIG. 13 is a side cross-sectional view of the spray head assembly of FIG. 1;

FIG. 14 is a side cross-sectional view of the spray head assembly of FIG. 7;

FIG. 15A is a bottom perspective view of the spray head assembly of FIG. 1 illustrating a first disassembly operation to access a filter element, according to an embodiment;

FIG. 15B is a bottom perspective view of the spray head assembly of FIG. 1 illustrating a second disassembly operation to access a filter assembly, according to an embodiment;

FIG. 16 is a bottom view of a spray head assembly, according to another embodiment;

FIG. 17 is a side view of the spray head assembly of FIG. 16;

FIG. 18 is a top view of the spray head assembly of FIG. 16;

FIG. 19A is a perspective view of a filter housing, according to an embodiment;

FIG. 19B is a side cross-sectional view of the filter housing of FIG. 19A;

FIG. 20 is an exploded bottom perspective view of a spray head assembly including a filter assembly, according to an embodiment;

FIG. 21 is an exploded top perspective view of the spray head assembly of FIG. 20;

FIG. 22 is an exploded bottom perspective view of a spray head assembly including a filter assembly, according to an embodiment;

FIG. 23 is a perspective view of a filter assembly, according to an embodiment; and

FIG. 24 is a perspective view of a spray head assembly including a filter, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Embodiments of the present disclosure relate to a spray head assembly, such as a showerhead assembly, that includes a removable filter assembly for removing contaminants and impurities from a water supply. In some embodiments, the spray head assembly is a self-contained showerhead assembly that includes a single inlet connector and spray face that are integrally formed into a shared housing structure that also contains the removable filter assembly. The spray head assembly may also include a filter support structure that supports a common filter assembly design within various different spray head structures and/or aesthetics. The filter support structure also enables replacement of the filter assembly by hand without the use of mechanical fasteners. The spray head assembly includes an inlet assembly configured to receive a supply of fluid, a body fluidly coupled with the inlet assembly, and a head portion configured to receive the fluid from the body and discharge the fluid through a plurality of nozzles. The body defines an interior chamber to receive the filter support structure. The filter support structure houses the filter assembly. The body and the head portion may be removably coupled (e.g., rotatably removably coupled) to each other, which simplifies filter replacement operations, and can ensure a more watertight seal between the filter assembly and the spray head assembly. When the body and the head portion are separated, a bottom wall of the filter support may remain coupled with the head portion and a top wall of the filter support may remain coupled with the body, thereby facilitating access to the filter support structure to replace the filter assembly.

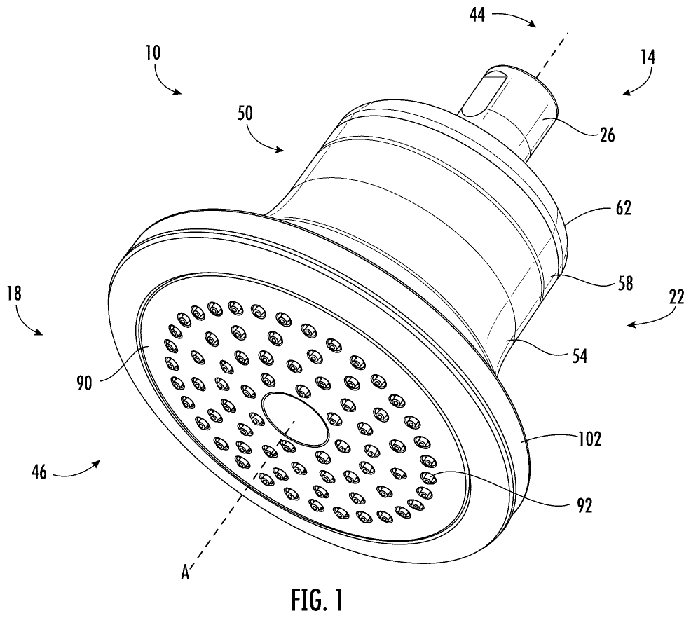

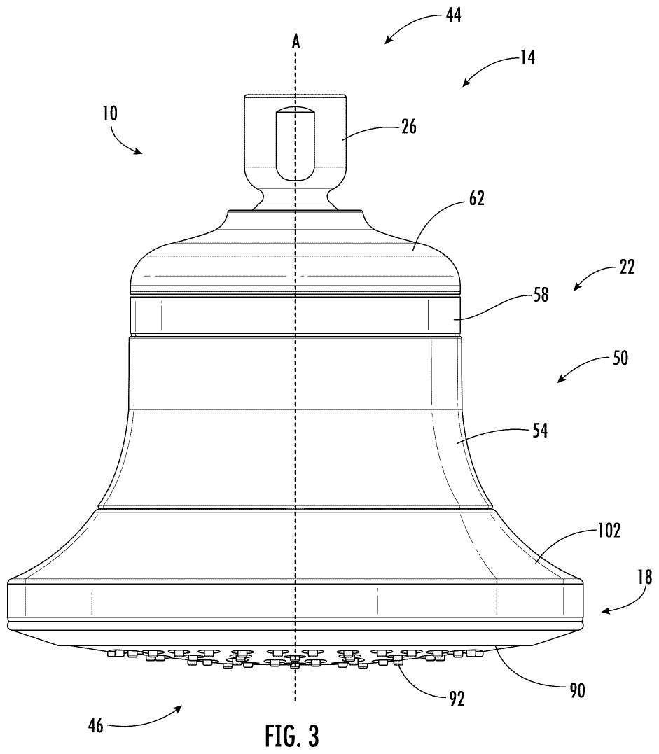

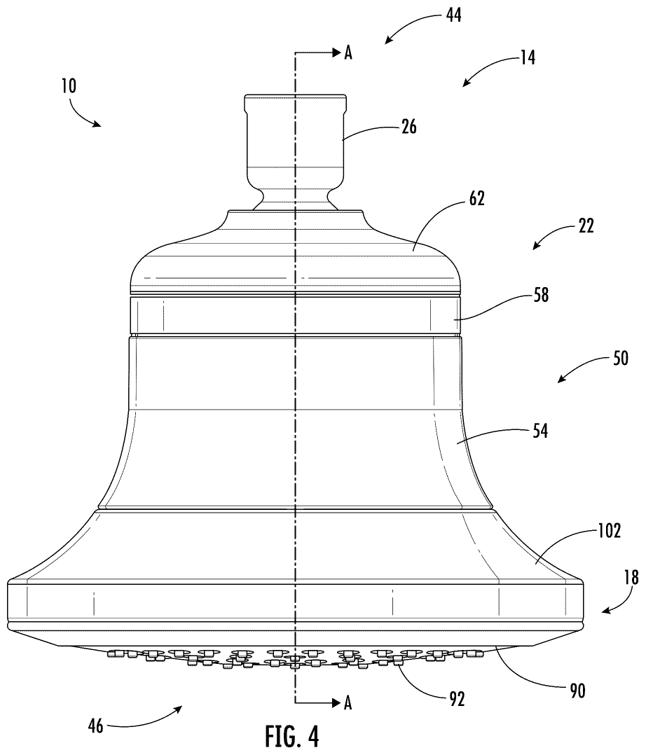

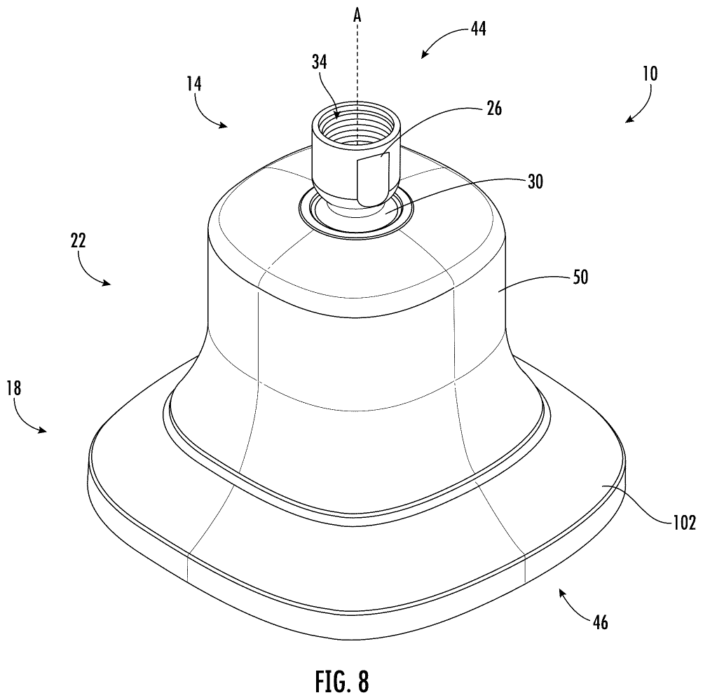

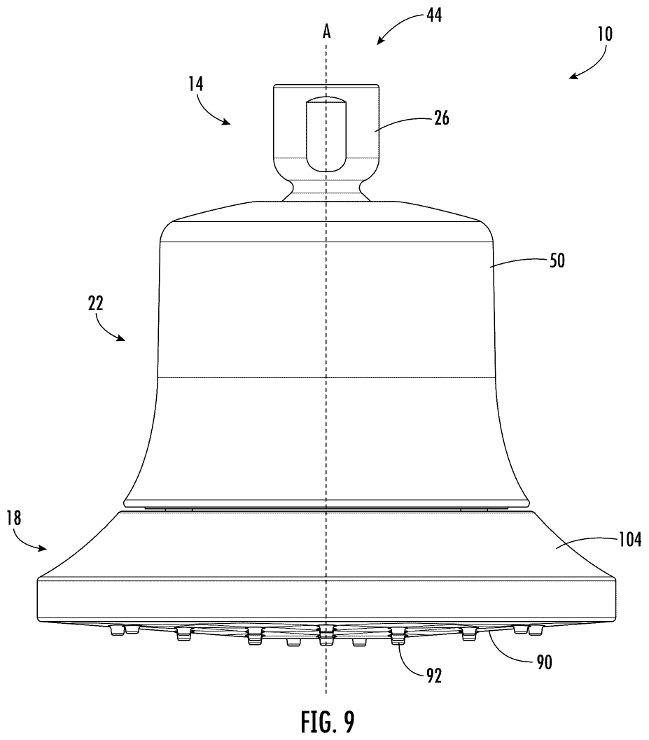

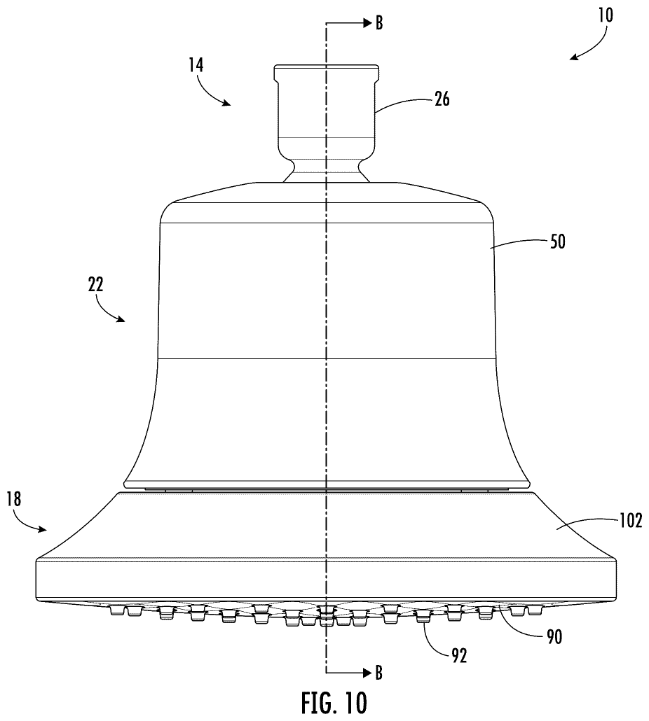

Referring to FIGS. 1-12, a spray head assembly (e.g., a showerhead assembly, a faucet spray head assembly, etc.) is shown as spray head assembly 10, according to an embodiment. The spray head assembly 10 includes an inlet assembly (e.g., an inlet, etc.), shown as inlet assembly 14, configured to fluidly couple to a fluid source (e.g., a well, a plumbing system, etc.) to receive a supply of fluid (e.g., water); an outlet assembly (e.g., an outlet, etc.), shown as head portion 18, configured to discharge the fluid; and a body assembly (e.g., a shell, an outer body, a casing, etc.), shown as body 22, extending between the head portion 18 and the inlet assembly 14 and configured to fluidly connect the inlet assembly 14 with the head portion 18. By way of example, the body 22 defines a channel, a passage, a bore, etc. to supply the fluid received by the inlet assembly 14 to the head portion 18 to be discharged therefrom. In at least one embodiment, the spray head assembly 10 is a showerhead assembly that is configured to receive unfiltered water from a water supply (e.g., a water supply conduit, a water supply pipe, a water supply line, etc.) and to distribute a spray of clean, filtered water into a shower enclosure. The spray head assembly 10 may be configured to discharge water in a spray pattern defined by the head portion 18.

The inlet assembly 14 includes a fluid communication member (e.g., a tube, a pipe, a conduit, etc.), shown as connector 26, configured to fluidly couple the spray head assembly 10 to a fluid delivery component (e.g., a pipe, a spout, a fixture, a shower arm, etc.) such that the spray head assembly 10 can receive the fluid from the fluid source. In some embodiments, the fluid delivery component is a water supply conduit that is configured to supply water at residential and/or commercial water supply pressures. In some embodiments, the connector 26 includes threads that screw to the fluid delivery component. In such embodiments, the connector 26 facilitates selectively coupling the spray head assembly 10 with the fluid delivery component. In some embodiments, the spray head assembly 10 is configured as a pull-out spray head, where the spray head assembly 10 can be selectively removed from and reattached to the fluid delivery component. Alternatively, the spray head assembly 10 may be fixedly coupled to the fluid delivery component.

In some embodiments, the inlet assembly 14 is configured to pivotably couple the spray head assembly 10 to the fluid delivery component so that the spray head assembly 10 can pivot relative to the inlet assembly 14. The inlet assembly 14 includes a ball joint 30 (e.g., a spherical element, etc.) attached to the connector 26. When the inlet assembly 14 fluidly couples the spray head assembly 10 to the fluid delivery component, the spray head assembly 10 is pivotable about the ball joint 30 (e.g., pivotable about a center point of the ball joint 30) relative to the inlet assembly 14 and the fluid delivery component. The connector 26 and the ball joint 30 together define a fluid passage 34 that extends through the ball joint 30 and the connector 26 to supply the fluid to the head portion 18 (e.g., through the body 22) to be discharged therefrom. In some embodiments, the inlet assembly 14 includes a flow regulator 38 to regulate the pressure of the flow of the fluid to the body 22 and the head portion 18. In some embodiments, the inlet assembly includes a filter, shown as screen 42, to filter particulates from flowing in the fluid passage 34, past the screen 42, and to the body 22 and the head portion 18.

Referring to FIGS. 1-12, the body 22 is configured to receive at least a portion of the inlet assembly 14 at a first end 44 of the body 22. The body 22 is configured to receive at least a portion of the head portion 18 at a second end 46 of the body 22 to fluidly couple the inlet assembly 14 with the head portion 18. The body 22 includes at least one housing member (e.g., casing member, wall, exterior shell, etc.), shown as housing 50, defining an interior chamber (e.g., a space) to house one or more internal components (e.g., valves, filters, actuators, conduits, etc.) of the spray head assembly 10 therein. The housing 50 extends along a longitudinal axis A between the inlet assembly 14 and the head portion 18.

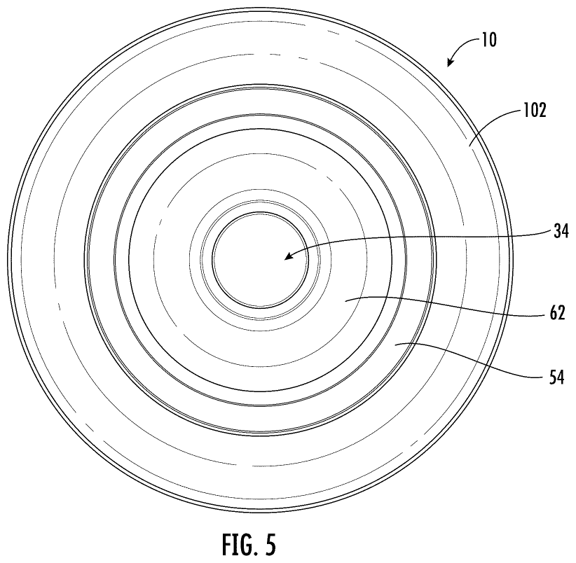

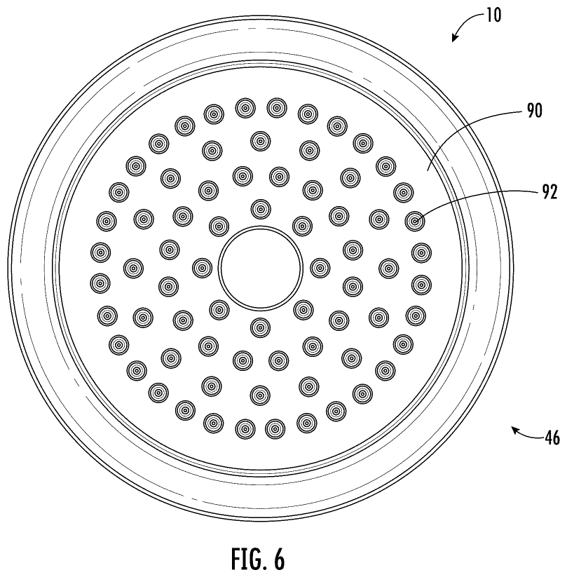

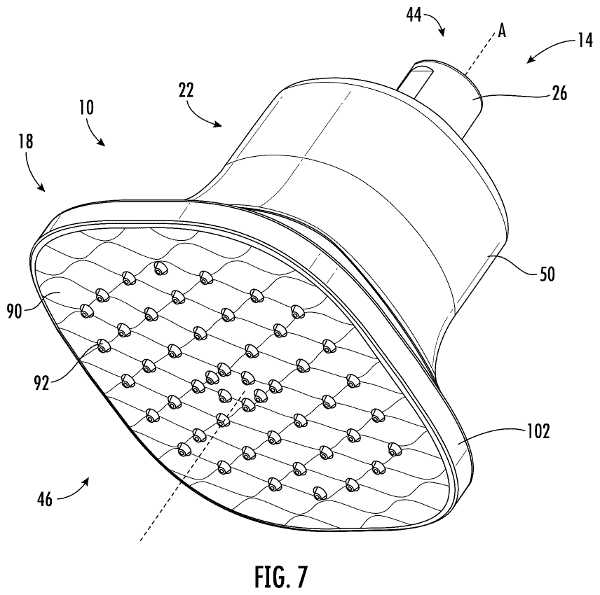

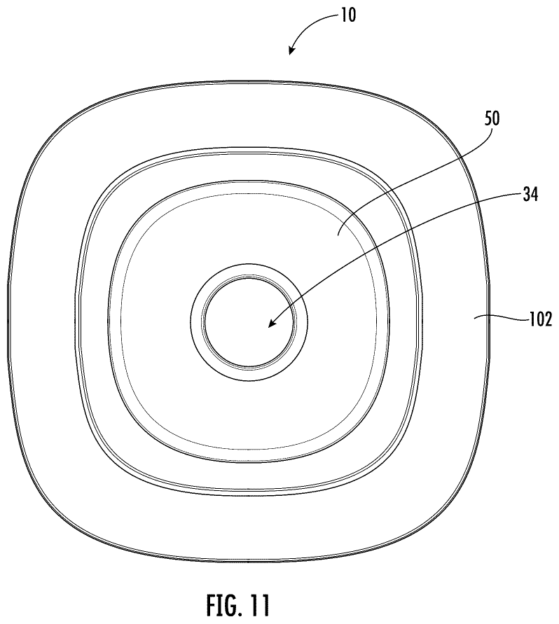

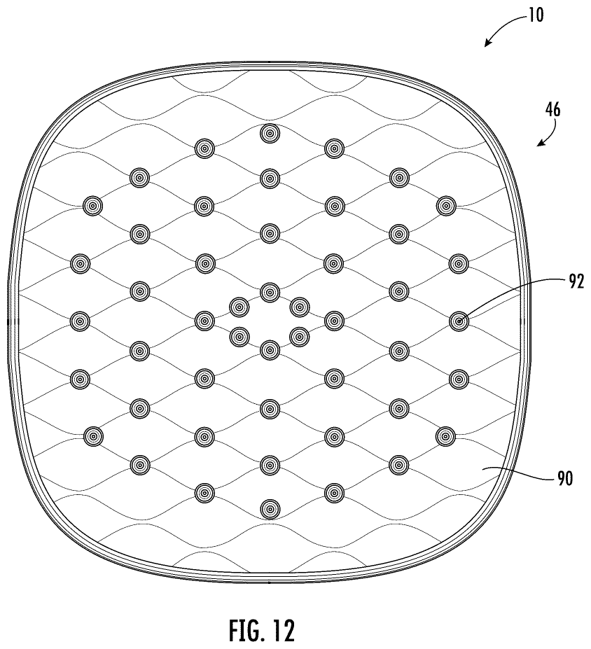

In the embodiment of FIGS. 1-6, the housing 50 is generally cylindrically shaped (e.g., annular). In such an embodiment, the housing 50 defines a generally circular (e.g., annular, ovular, etc.) profile (as best shown in the top view of FIG. 5 and the bottom view of FIG. 6). In the embodiment of FIGS. 7-12, the housing 50 is generally cuboidally (e.g., cubically) shaped having substantially planar sidewalls. In such an embodiment, the housing 50 defines a generally square (e.g., rectangular, quadrilateral, etc.) profile (as best shown in the top view of FIG. 11 and the bottom view of FIG. 12). In yet other embodiments, the housing 50 forms a different shape or profile.

Referring to FIGS. 1-6, the housing 50 includes a first annular portion (e.g., a shell, a casing, etc.), shown as lower shell 54, a second annular portion (e.g., an annular member, a selector, etc.), shown as date band 58, and a third annular portion (e.g., a shell, a casing, etc.), shown as upper shell 62. Each of the lower shell 54, the date band 58, and the upper shell 62 may be rotatably coupled to each other to enable relative rotation therebetween. By way of example, the lower shell 54, the date band 58, and the upper shell 62 may be (i) concentric and (ii) movable (e.g., rotatable) relative to each other about the longitudinal axis A defined by the body 22.

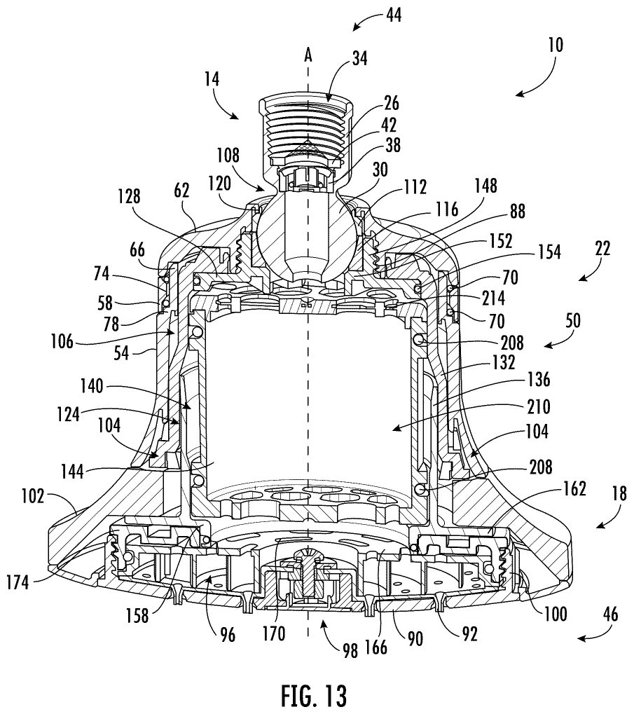

As shown in FIG. 13, the lower shell 54 includes a flange 66 positioned radially inward relative to the date band 58 and at least a portion of the upper shell 62. The flange 66 may be configured to engage with an inner radial surface of the date band 58. In some embodiments, one or more sealing members (e.g., gaskets), shown as O-rings 70, are coupled to the outer radial surface of the flange 66 and positioned between (e.g., radially between) the flange 66 and the date band 58. The O-rings 70 may engage with the inner radial surface of the date band 58 and the outer radial surface of the flange 66 to form a seal (e.g., a watertight seal) therebetween. In other embodiments, the lower shell 54 is integrally formed with the upper shell 62 as a single unitary body (e.g., as a single monolithic piece that cannot be separated without damaging the lower shell 54 or the upper shell 62) and the date band 58 is slidably engaged with the upper shell 62 and/or the lower shell 54 (e.g., in a groove and/or channel defined by the upper shell 62 and/or the lower shell 54).

In some embodiments, the date band 58 includes a protrusion 74 along the inner radial surface thereof structured to support the one or more O-rings 70. In some embodiments, the flange 66 is stepped radially inwards relative to an outer surface of the lower shell 54 by a step 78. The step 78 may be structured to support the one or more O-rings 70. The step 78 and the protrusion 74 may cooperate to support the one or more O-rings 70 thereon. A friction force between the O-rings 70, the flange 66, and the date band 58 may secure the orientation of the date band 58 relative to the lower shell 54 to prevent inadvertent movement of the date band 58 during use. A user may engage with the date band 58 to overcome the friction force and rotate the date band 58 relative to the lower shell 54 to a desired orientation.

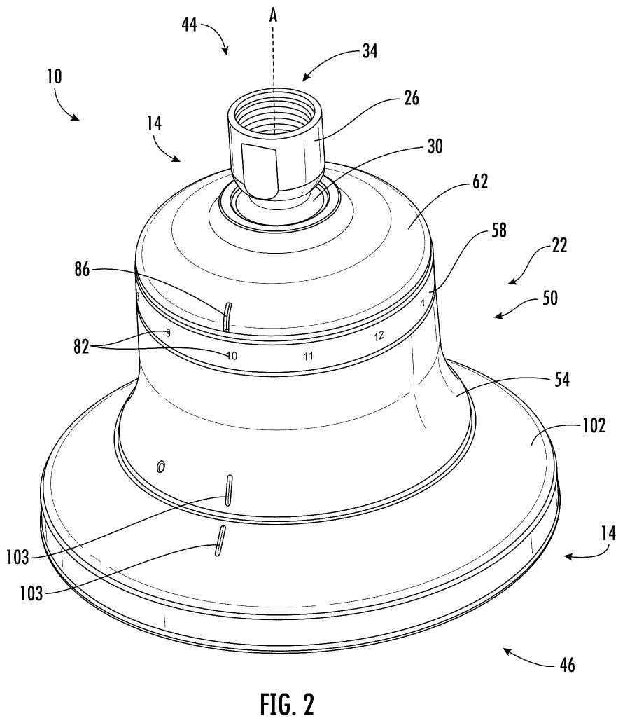

Referring to FIG. 2, the date band 58 includes the numbers “1” through “12”, shown as numbers 82 along an outer radial surface thereof. In other embodiments, the date band 58 may include another form of service life indicator. The upper shell 62 includes an alignment feature 86 (e.g., a line, an arrow, a mark, a protrusion, etc.) along the outer radial surface thereof and located proximate the date band 58. The numbers 82 and the alignment feature 86 may be molded, etched, engraved, embossed, debossed, adhered (e.g., as a sticker), painted, or otherwise applied to the date band 58 and the upper shell 62, respectively. A user may rotate the date band 58 and the upper shell 62 relative to each other to substantially align one of the numbers 82 with the alignment feature 86. In some embodiments, the numbers 82 are representative of a certain month of the year (e.g., “1” corresponding with January, “2” corresponding with February, . . . , “12” corresponding with December) such that aligning one of the numbers 82 with the alignment feature 86 is indicative of when (e.g., a day, a month, a year, etc. in which) an action should be carried out by the user. By way of example, the user may rotate the date band 58 to set a date (e.g., set a month) when one or more of the components of the spray head assembly 10 (e.g., valves, filters, actuators, conduits, etc.) should be serviced, replaced, cleaned, etc.

By way of another example, if a filter (e.g., filter assembly 144) with a recommended life-span of six months is replaced in February, the user may align the number “8” (corresponding with August, six months from the replacement date in February) with the alignment feature 86, thereby reminding the user to replace the filter. Additionally, or alternatively, the numbers 82 representative of the months of the year may be represented on the date band 58 in another format (e.g., spelled out, abbreviated, in braille, etc.). In some embodiments, the numbers “1” through “31” indicative of a day of the month are included on the date band 58 (e.g., instead of the numbers “1” through “12” indicative of the month) or are included on a second date band 58 of the body 22.

In yet other embodiments, the spray head assembly 10 includes another type of indicator to visually notify a user to service the filter or another component of the spray head assembly 10. For example, the spray head assembly 10 may include a light element (e.g., a light emitting diode, etc.) configured to indicate a remaining service life of the filter element (e.g., based on a color of the light element, etc.). In yet other embodiments, the spray head assembly 10 includes a sensor (e.g., a pressure sensor, etc.) communicably coupled to the indicator and configured to transmit a control signal to the indicator to notify the user when the filter needs to be replaced (e.g., when a pressure drop measured by the sensor exceeds or otherwise satisfies a pressure threshold, etc.).

In some embodiments, as shown in FIGS. 7-12, and as described above, the housing 50 does not include the date band 58. In such embodiments, the housing 50 is formed as a single unitary body (e.g., shell). In other words, in such embodiments, the lower shell 54 and the upper shell 62 are integrally formed with each other as a single unitary body.

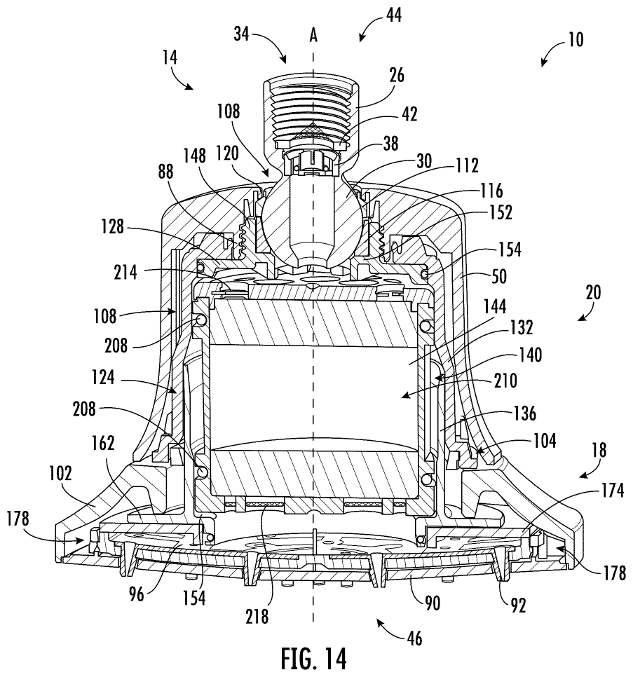

Referring to FIGS. 13 and 14, the housing 50 includes a connector flange 88 (e.g., a threaded flange, a support member, etc.) extending from a portion of the housing 50 proximate the first end 44 (e.g., from the upper shell 62, from a portion of the housing 50 proximate the opening 108). The connector flange 88 may extend within the interior chamber of the housing 50 (e.g., interior chamber 106, which may also be referred to as an interior cavity, a hollow portion, etc.) in a direction towards the second end 46. In some embodiments, the connector flange 88 may be concentric with the longitudinal axis A. The connector flange 88 includes internal threads that screw to a portion of a filter housing (e.g., filter housing 124) to facilitate selectively coupling the filter housing with the housing 50.

As shown in FIGS. 1-12, the head portion 18 includes a spray face 90 fluidly coupled with the body 22 and the inlet assembly 14. The spray face 90 includes a plurality of apertures through which a plurality of nozzles 92 extend. The plurality of nozzles 92 are variously positioned about the spray face 90 and are configured to direct the fluid into a spray pattern (e.g., a spray pattern based on the arrangement of the nozzles 92), thereby discharging the fluid from the head portion 18 and the spray head assembly 10.

In some embodiments, as shown in FIGS. 1 and 6, the nozzles 92 are arranged in an annular pattern concentric about the longitudinal axis A. In such embodiments, the spray face 90 is substantially circular (e.g., annular, ovular, etc.). In other embodiments, as shown in FIGS. 7 and 12 the nozzles 92 are arranged in a prismed pattern about the spray face 90. In such embodiments, the spray face 90 is substantially square (e.g., rectangular, quadrilateral, etc.). In yet other embodiments, the nozzles 92 may be arranged in a different pattern about the spray face 90.

In some embodiments, the spray face 90 includes a first set of nozzles 92 configured to discharge the fluid in a first pattern and a second set of nozzles 92 configured to discharge the fluid in a second pattern that is different from the first pattern. In such an embodiment, the fluid may be selectively discharged through the first set of nozzles 92 and/or the second set of nozzles 92.

As shown in FIGS. 13 and 14, the nozzles 92 are fluidly coupled with one or more fluid channels 96 (e.g., fluid conduits, fluid paths, etc.) configured to supply fluid received from the inlet assembly 14 and through the body 22 to the nozzles 92. In some embodiments, the channels 96 are spaced from each other such that a first channel 96 supplies fluid to first nozzles 92 (e.g., a first sub-set of nozzles 92) and a second channel 96 (e.g., a next radial outward channel 96) supplies fluid to second nozzles 92 (e.g., a second sub-set of nozzles 92) arranged radially outwards relative to the first nozzles 92. As shown, the spray face 90 includes a fastener assembly 98 (e.g., a nut and bolt assembly, a coupling assembly, a fastener mechanism, etc.) configured to couple a structure (e.g., the control member 166) including the channels 96 to an interior facing surface of the spray face 90 (e.g., a surface of the spray face 90 facing the interior chamber 106).

In the embodiment of FIGS. 13 and 14, the spray face 90 includes a connector flange 100 (e.g., threaded flange, support member, etc.) extending from the spray face 90 (e.g., from an interior facing surface of the spray face 90). The connector flange 100 may extend within the interior chamber of the housing 50 (e.g., interior chamber 106) in a direction towards the first end 44. The connector flange 100 may be positioned proximate an outer radial edge of the spray face 90. The connector flange 100 may be concentric with the longitudinal axis A. The connector flange 100 includes internal threads that screw to a portion of a filter housing (e.g., filter housing 124) to facilitate selectively coupling the filter housing with the spray face 90 and the head portion 18.

The head portion 18 includes a head shell 102 concentric with the longitudinal axis A and positioned proximate the second end 46 of the spray head assembly 10. An outer radial surface of the head shell 102 may substantially align and be substantially flush with an outer radial surface of the housing 50 (e.g., with the lower shell 54 of the housing 50) when the head portion 18 is engaged with and rotatably coupled to the body 22, such that the spray head assembly 10 defines a continuous outer profile.

The body 22 may be selectively and removably coupled with the head portion 18 such that the one or more internal components housed within the interior chamber of the housing 50 are accessible to a user without damaging the spray head assembly 10. In some embodiments, when the body 22 and the head portion 18 are decoupled (e.g., separated, removed) from each other, the inlet assembly 14 remains rotatably coupled with the body 22. Decoupling the body 22 and the head portion 18 from each other may facilitate access to the interior chamber to service, replace, clean, etc. the one or more internal components of the spray head assembly 10.

In some embodiments, the lower shell 54 of the housing 50 and the head shell 102 of the head portion 18 are detachably and rotatably coupled to one another to facilitate access to the interior chamber 106. In some embodiments, as shown in FIG. 2, the lower shell 54 of the housing 50 and the head shell 102 of the head portion 18 each include an alignment feature 103 (e.g., a line, an arrow, a mark, a protrusion, etc.) along the outer radial surface thereof. The alignment features 103 may be molded, etched, engraved, embossed, debossed, adhered (e.g., as a sticker), painted, or otherwise applied to the lower shell 54 and the head shell 102, respectively. A user may rotate the body 22 and the head portion 18 relative to each other to an alignment position to align the respective alignment features 103 of the lower shell 54 and the head shell 102.

In some embodiments, an alignment of the respective alignment features 103 of the lower shell 54 and the head shell 102 is indicative of the spray head assembly 10 being in an unlocked configuration such that the body 22 and the head portion 18 can be freely decoupled from each other. In other embodiments, an alignment of the respective alignment features 103 of the lower shell 54 and the head shell 102 is indicative of the spray head assembly 10 being in a locked configuration such that the body 22 and the head portion 18 are coupled together.

In some embodiments, such as the embodiments shown in FIGS. 7-12, (e.g., when the housing 50 is formed as a single unitary body, the lower shell 54 and the upper shell 62 are integrally formed with each other as a single unitary body, etc.), the housing 50 and the head shell 102 do not include the alignment features 103. In such an embodiment, an alignment of the shape (e.g., profile) of the housing 50 with the shape (e.g., profile) of the head shell 102 (e.g., rotating the housing 50 and the head shell 102 to the alignment position) is indicative of the spray head assembly 10 being in the unlocked configuration or the locked configuration. By way of example, as discussed above, the housing 50 and the head shell 102 may define generally square profiles. In such an example, aligning a first cross-sectional (e.g., square) profile of the housing 50 with a second cross-sectional (e.g., square) profile of the head shell 102 may be indicative of the spray head assembly 10 being in the unlocked configuration or the locked configuration.

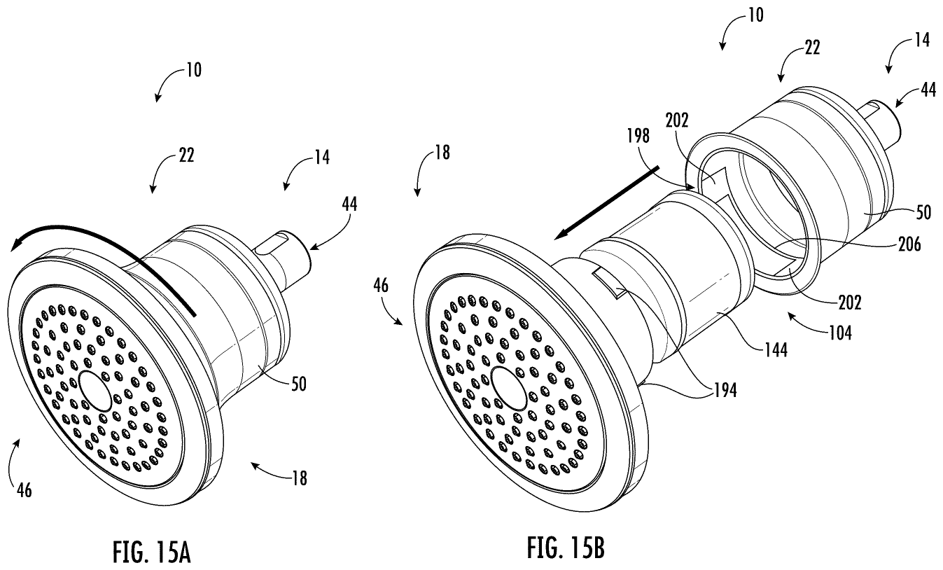

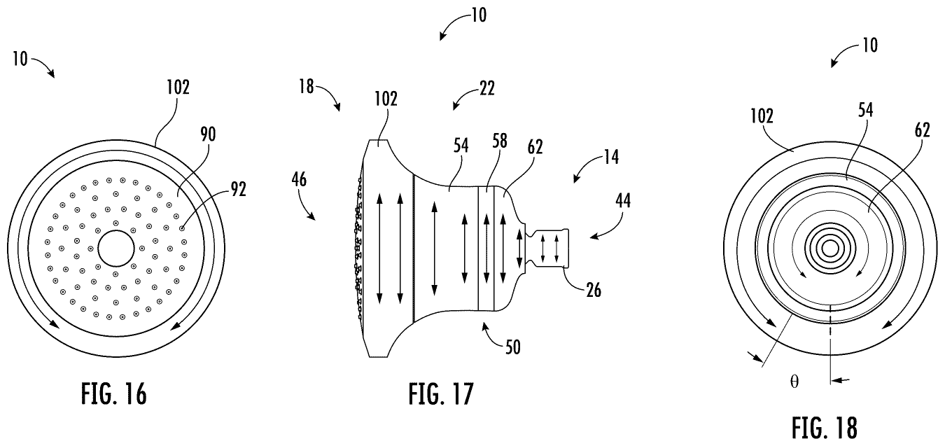

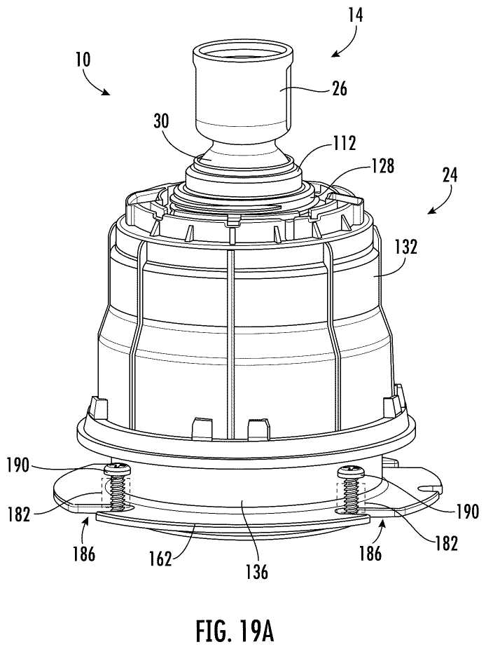

As shown in FIGS. 15A-15B, and FIGS. 16-18, the body 22 and the head portion 18 may rotate relative to each other to selectively couple with each other. By way of example, any one of the head portion 18, the body 22 (e.g., the housing 50, the lower shell 54, the date band 58, or the upper shell 62), or the inlet assembly 14 can rotate relative to any other one of the head portion 18, the body 22, or the inlet assembly 14. The spray head assembly 10 includes a locking system 104 (e.g., a turn mechanism, a guide, etc.) configured to inhibit rotation of the body 22 and the head portion 18 relative to each other and selectively couple the body 22 with the head portion 18. The locking system 104 facilitates transitioning the spray head assembly 10 between the locked configuration and the unlocked configuration.

In some embodiments, when the spray head assembly 10 is in the locked configuration such that the body 22 and the head portion 18 are coupled with each other, the body 22 and the head portion 18 may be rotated a certain angle, shown as angle θ, relative to each other to transition the spray head assembly 10 to the unlocked configuration. The angle θ may be about 30 degrees (e.g., 27 degrees, 33 degrees, etc.). In some embodiments, the angle θ is greater than or less than 30 degrees (e.g., 10 degrees, 45 degrees, 90 degrees, 180 degrees, 360 degrees, etc.). The locking system 104 may prevent the body 22 and the head portion 18 from rotating relative to each other more than the angle θ.

Referring back to FIGS. 13 and 14, the housing 50, the head shell 102, and the spray face 90 (e.g., interior facing surfaces of the housing 50, the head shell 102, and the spray face 90) collectively define an interior chamber 106 of the spray head assembly 10. The housing 50 includes an aperture (e.g., opening, hole, space, etc.), shown as opening 108, proximate the first end 44 and structured to receive the ball joint 30 of the inlet assembly 14. The inlet assembly 14 (e.g., the connector 26) may extend through the opening 108. In other words, when the inlet assembly 14 fluidly couples the spray head assembly 10 to the fluid delivery component, at least a portion of the inlet assembly 14 (the ball joint 30) is positioned within (e.g., extends inside of) the interior chamber 106, and at least a portion of the inlet assembly 14 (the connector 26) is positioned outside of (e.g., extends through the opening 108) the interior chamber 106. The opening 108 is sized such that the housing 50 (and the body 22 and the head portion 18) is pivotable about the ball joint 30 (e.g., pivotable about a center point of the ball joint 30) relative to the inlet assembly 14 and the fluid delivery component.

In at least one embodiment, the spray head assembly 10 includes a first compressible member 112 and a second compressible member 116 positioned within the opening 108 of the housing 50. The first compressible member 112 may be disposed along and contact an upper portion of the ball joint 30 (e.g., a portion of the ball joint 30 closer to the first end 44). The first compressible member 112 may engage with a lip 120 of the housing 50. The lip 120 may be structured to inhibit translation of the first compressible member 112 within the opening 108 along the longitudinal axis A (e.g., to inhibit translation of the first compressible member 112 in a direction towards the first end 44, etc.).

The second compressible member 116 may be disposed along and contact a lower portion of the ball joint 30 (e.g., a portion of the ball joint 30 closer to the second end 46). The second compressible member 116 may be (i) engaged with and (ii) biased in a direction towards the first end 44 by a filter housing (e.g., filter housing 124). Biasing the second compressible member 116 in a direction towards the first end 44 loads the first compressible member 112 between the lip 120 of the housing 50 and the ball joint 30. This loading induces friction, which is tailorable to maintain the spray head assembly 10 (e.g., the head portion 18) in any moved position by a user. The first and second compressible members 112, 116 can be made of or include a resilient/compressible material, such as an elastomer or other suitable material.

Referring to FIGS. 13, 14, 19A, and 19B, the interior chamber 106 may be sized to receive a filter housing 124 therein. The filter housing 124 includes a first filter housing member (e.g., sidewall, casing, surface, connector, etc.), shown as top wall 128, configured to selectively couple the filter housing 124 to the housing 50 within the interior chamber 106; a second filter housing member (e.g., sidewall, casing, etc.), shown as upper sidewall 132; and a third filter housing member (e.g., sidewall, casing, etc.), shown as lower sidewall 136. Collectively, the top wall 128, the upper sidewall 132, and the lower sidewall 136 form an interior chamber (e.g., a space, a volume, etc.), shown as filter chamber 140. The filter chamber 140 is sized to receive a filter assembly 144 (discussed below) therein. The filter assembly 144 is configured to filter the fluid supplied from the inlet assembly 14 to the head portion 18. In some embodiments, the top wall 128, the upper sidewall 132, and/or the lower sidewall 136 are made from two or more sections of material. In some embodiments, the top wall 128 and the upper sidewall 132 are integrally formed with each other as a single unitary body.

As shown in FIGS. 13 and 14, the top wall 128 includes a connector flange 148 (e.g., threaded flange, support member, etc.) extending from the top wall 128 (e.g., from an exterior facing surface of the top wall 128). The connector flange 148 may extend within the interior chamber 106 in a direction towards the first end 44 (e.g., when the filter housing 124 is coupled to the housing 50). The connector flange 148 may be concentric with the longitudinal axis A when the filter housing 124 is coupled to the housing 50. The connector flange 148 includes external threads that screw to the interior threads of the connector flange 88 of the housing 50 to facilitate selectively coupling the filter housing 124 with the housing 50 and the body 22.

The top wall 128 may include a step portion (e.g., a support surface), shown as step 152, structured to engage with the second compressible member 116. The step 152 may contact a bottom surface of the second compressible member 116 to support the second compressible member 116. The step 152 may bias the second compressible member 116 in a direction towards the first end 44 when the filter housing 124 is engaged with (e.g., screwed into) the housing 50. By way of example, the internal threads of the connector flange 88 may mesh or otherwise engage with the external threads of the connector flange 148 to couple the filter housing 124 with the housing 50, thereby biasing the second compressible member 116 in a direction towards the first end 44. Biasing the second compressible member 116 in a direction towards the first end 44 against the ball joint 30 loads the first compressible member 112 between the lip 120 of the housing 50 and the ball joint 30. This loading induces friction, which is adjustable to maintain the spray head assembly 10 (e.g., the head portion 18) in any moved position by a user. In some embodiments, an interior facing radial surface of the connector flange 148 (e.g., a surface of the connector flange 148 opposite the external threads thereof) may engage with an exterior facing radial surface of the second compressible member 116 to support the second compressible member 116. The top wall 128 includes an opening to receive the fluid from the fluid passage 34 of the inlet assembly 14 and supply the fluid to the filter chamber 140 and the filter assembly 144.

The upper sidewall 132 of the filter housing 124 extends from the top wall 128. The upper sidewall 132 may engage with an upper surface (e.g., the exterior facing surface) of the top wall 128 and an exterior facing radial surface of the connector flange 88 of the housing 50. In some embodiments, an O-ring 154 is positioned between the top wall 128 and the upper sidewall 132. In some embodiments, when the body 22 and the head portion 18 are coupled together, the upper sidewall 132 extends in a direction from the top wall 128 to the head shell 102. In such an embodiment, the upper sidewall 132 overlaps at least a portion of the lower sidewall 136. By way of example, at least a portion of the lower sidewall 136 may be received by the upper sidewall 132 (e.g., within a portion of the filter chamber 140 defined by the upper sidewall 132) such at least a portion of the lower sidewall 136 is positioned radially inwards relative to the upper sidewall 132.

As shown in FIGS. 13 and 14, the lower sidewall 136 includes a shoulder 158 (e.g., a lip, a support, a flange, etc.), extending radially inward. The shoulder 158 is configured to engage with the filter assembly 144 (e.g., a bottom surface/wall of the filter assembly 144) to support the filter assembly 144 when it is received within the filter chamber 140 of the filter housing 124. The shoulder 158 includes an opening such that fluid filtered by the filter assembly 144 is supplied to the channels 96 and discharged through the nozzles 92. In some embodiments, the opening of the shoulder 158 is concentric with the longitudinal axis A.

In some embodiments, the lower sidewall 136 includes a bottom flange 162 configured to engage with a control member 166. The control member 166 may include a plurality of slots 170 variously (e.g., annularly) positioned about the control member 166. The slots 170 may be fluidly coupled with the channels 96 and the opening defined by the shoulder 158 of the lower sidewall 136. The slots 170 may be variously sized to control the flow rate of the fluid supplied to the channels 96 and the nozzles 92. In other embodiments, as shown in FIG. 14, the spray head assembly 10 does not include the control member 166. In such embodiments, the channels 96 and the nozzles 92 are fluidly coupled directly with the opening defined by the shoulder 158.

In some embodiments, as shown in FIG. 13, the filter housing 124 includes a connector 174 positioned between the bottom flange 162 and the spray face 90. The connector 174 may include exterior threads configured to engage with the connector flange 100 of the spray face 90 to selectively couple the spray face 90 (and the head portion 18) with the filter housing 124. In some embodiments, O-rings are positioned between (i) the connector 174 and the lower sidewall 136 and (ii) between the connector 174 and the control member 166. In other embodiments, as shown in FIG. 14, the connector 174 does not include exterior threads. In such an embodiment, the spray face 90 may couple to the connector 174 by way of one or more clips 178.

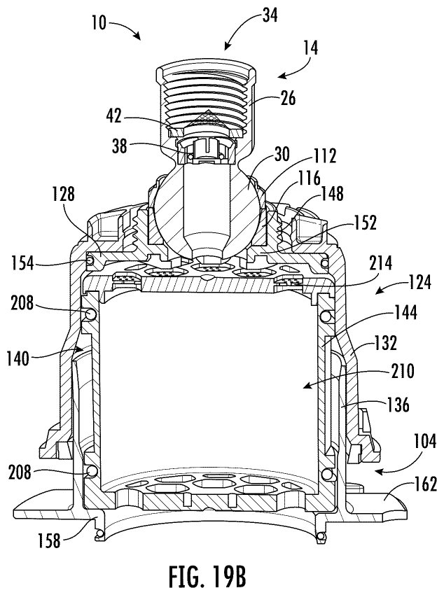

As shown in FIG. 19A, the connector 174 includes one or more fastener receivers 182 extending in a direction towards the first end 44 from the connector 174. The fastener receivers 182 may be received by apertures 186 annularly positioned along the bottom flange 162 of the lower sidewall 136. The fastener receivers 182 may receive a fastener 190 to couple the connector 174 with the lower sidewall 136, thereby coupling the head portion 18 with the filter housing 124.

Referring to FIGS. 19A and 19B, the spray head assembly 10 supports a common filter assembly design (e.g., a common filter housing 124) that may be used with various different structures and/or aesthetics of the body 22 (e.g., the housing 50) and/or the head portion 18 (e.g., the head shell 102). By way of example, the filter housing 124 may be received in either the housing 50 of the embodiment of FIGS. 1-6 (e.g., the cylindrically shaped housing 50) or the housing 50 of the embodiment of FIGS. 7-12 (e.g., the cuboidally shaped housing 50). In other words, the spray head assembly 10 may be configurable both as (i) a first spray head assembly 10 including the housing 50 and the head portion 18 defining a first shape configured to receive the filter housing 124 and (ii) a second spray head assembly 10 including the housing 50 and the head portion 18 defining a second shape different than the first shape configured to receive the same filter housing 124.

Referring to FIGS. 15B, 20, and 21, when the body 22 is separated from the head portion 18, the top wall 128 and the upper sidewall 132 of the filter housing 124 may remain coupled with the body 22 and the lower sidewall 136 of the filter housing 124 may remain coupled with the head portion 18. As shown, the locking system 104 includes a plurality of protrusions, shown as engagement features 194. In some embodiments, the engagement features 194 extend from an interior surface of the upper sidewall 132 along the inner circumference thereof. In other embodiments, the engagement features 194 extend from an exterior surface of the lower sidewall 136 along an outer circumference thereof. The locking system 104 includes engagement track (e.g., guide, slot, etc.), shown as track 198. In some embodiments, the track 198 is positioned at an exterior surface of the lower sidewall 136 along an outer circumference thereof. In other embodiments, the track 198 is positioned at an interior surface of the upper sidewall 132 along the inner circumference thereof.

The track 198 includes a slot 202 configured to receive the engagement feature 194 and a guide 206 configured to inhibit longitudinal translation of the engagement feature 194 (e.g., translation of the body 22 relative to the head portion 18 along the longitudinal axis A) when the engagement feature 194 is received therein. The guide 206 may support the engagement feature 194 and permit rotation of the engagement feature 194 within the guide 206, thereby permitting relative rotation of the body 22 and the head portion 18. The guide 206 may inhibit rotation of the engagement feature 194 within the guide 206 beyond the angle θ, thereby inhibiting relative rotation of the body 22 and the head portion 18. By way of example, the engagement feature 194 may be received within the slot 202 and the body 22 may be rotated, thereby translating the engagement feature 194 within the guide 206 and transitioning the spray head assembly 10 to the locked configuration. Similarly, the body 22 may be rotated in an opposite direction, thereby translating the engagement feature 194 within the guide 206 and transitioning the spray head assembly 10 to the unlocked configuration. In the unlocked configuration, the engagement feature 194 and the slot 202 may be aligned such that the body 22 and the head portion 18 can be separated from each other. In some embodiments, the locking system 104 includes detents, notches, or similar features to provide tactile and audible feedback to the user when the spray head assembly 10 is transitioned between the locked configuration and the unlocked configuration. By way of example, when the body 22 and the head portion 18 are secured together, one or more components or features of the locking system 104 produce a tactile and/or audible feedback perceptible by the user. The tactile and/or audible feedback may be indicative of the spray head assembly 10 being transitioned to the locked configuration.

The filter housing 124 is configured to receive the filter assembly 144 within the filter chamber 140. When the body 22 is separated from the head portion 18, the upper sidewall 132 and the lower sidewall 136, at least partially defining the filter chamber 140, are separated such that the filter chamber 140 is accessible. The filter assembly 144 may be placed within the filter chamber 140. The body 22 and the head portion 18 may be coupled together with the filter assembly 144 received within the filter chamber 140 to transition the spray head assembly 10 to the locked configuration, thereby securing the filter assembly 144 within the filter chamber 140. In some embodiments, one or more O-rings 208 positioned between the exterior surface of the filter assembly 144 and the interior surface of the filter housing 124 to create a water-tight seal therebetween.

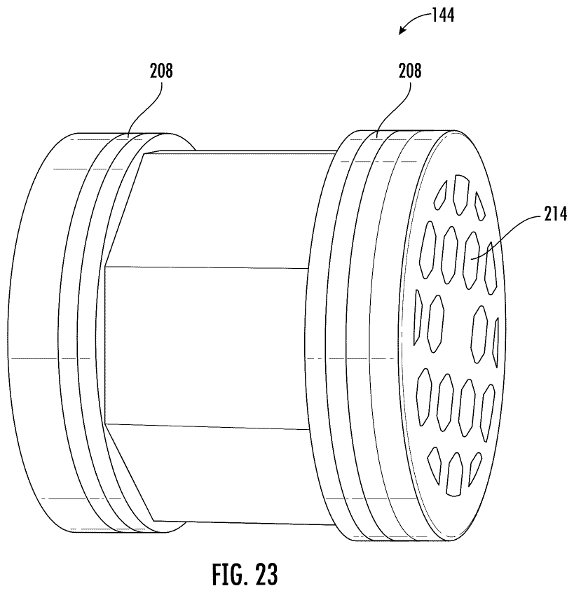

As shown in FIGS. 13, 14, and 20-24, the filter assembly 144 includes a fluid passage 210 configured to receive the fluid from the inlet assembly 14 and supply the fluid to the channels 96 to be discharged through the nozzles 92. The filter assembly 144 is configured to filter particulates, impurities, contaminants, and particles from the fluid as it is supplied therethrough. The filter assembly 144 includes a first filter (e.g., mesh layer), shown as first screen 214, positioned proximate the inlet assembly 14 (e.g., when the filter assembly 144 is received within the filter housing 124) and a second filter (e.g., mesh layer), shown as second screen 218, positioned proximate the spray face 90 (e.g., when the filter assembly 144 is received within the filter housing 124). The first and second screens 214, 218 are configured to prevent large particulates such as dirt, sand, stones, or any other debris from flowing in the fluid passage 210, past the first and second screens 214, 218, and to the nozzles 92. In some embodiments, the second screen 218 is finer than the first screen 214 to prevent smaller particulates from fluing in the fluid passage to the nozzles 92. The filter assembly 144 may be positioned within the filter chamber 140 such that the fluid filtered by the filter assembly 144 is supplied directly to the channels 96 to be discharged through the nozzles 92 (e.g., without passing or flowing through an intervening fluid passage defined by the body 22 or a separate conduit).

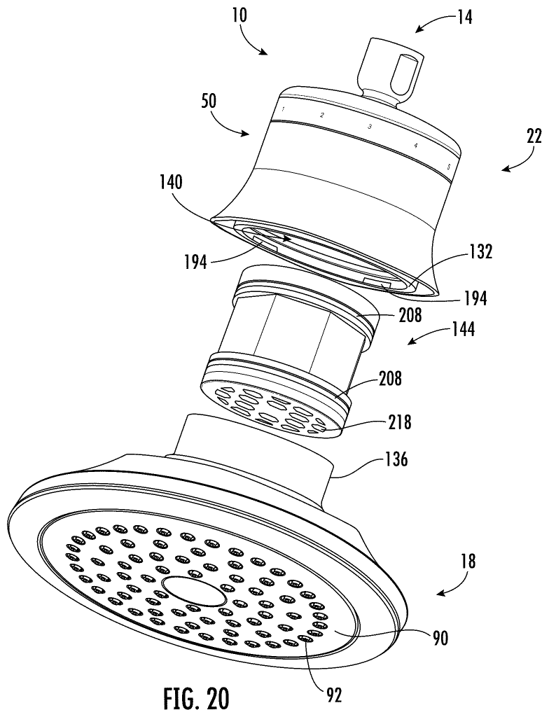

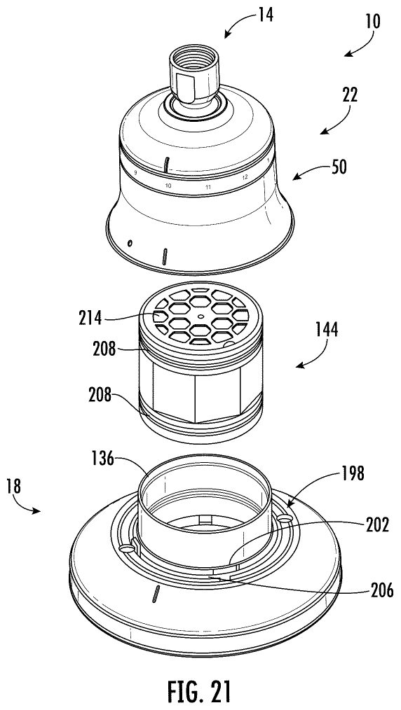

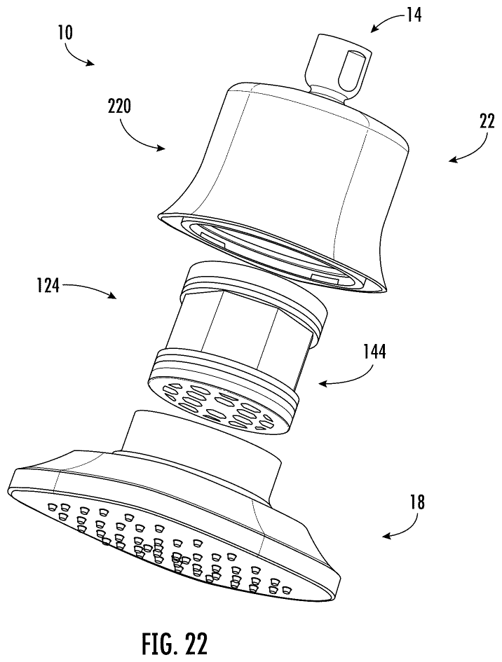

Referring to FIGS. 20-23, the spray head assembly 10 facilitates use of (e.g., installation of) the filter assembly 144 within the filter housing 124 the spray head assembly 10 with various different body 22 and/or head portion 18 structures and/or aesthetics. As shown in FIGS. 20 and 21, a common filter assembly 144 is received within the filter housing 124 when the housing 50 is generally cylindrically shaped (e.g., such as in the embodiment of FIGS. 1-6). As shown in FIG. 22, the common filter assembly 144 may be received within the filter housing 124 when the spray head assembly 10 includes a structure 220 that is generally cuboidally (e.g., cubically) shaped having substantially planar sidewalls (e.g., such as in the embodiment of FIGS. 7-12)

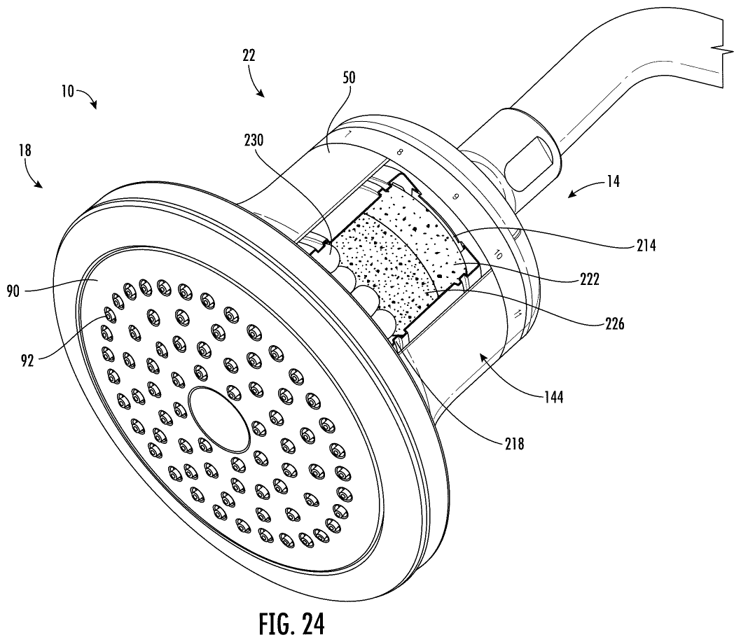

As shown in FIG. 24, the filter assembly 144 includes a third filter, shown as Kinetic Degradation Fluxion (KDF) layer 222, positioned within the fluid passage 210 below the first screen 214. The KDF layer 222 may be configured to remove or otherwise filter chlorine and organic constituents (e.g., bacteria) from the fluid. As shown, the filter assembly 144 includes a fourth filter, shown as charcoal layer 226, positioned within the fluid passage 210 below the KDF layer 222. The charcoal layer 226 may be configured to remove or otherwise filter chlorine and heavy metal (e.g., lead, mercury, zinc, copper, etc.) from the fluid. As shown, the filter assembly 144 includes a fifth filter, shown as antiscalant layer 230, positioned within the fluid passage 210 below the charcoal layer 226. The antiscalant layer 230 may be configured to reduce the formation of scale within the spray head assembly 10. In some embodiments, the KDF layer 222, the charcoal layer 226, and the antiscalant layer 230 are otherwise positioned or ordered. In other embodiments, the filter assembly 144 may include other materials to facilitate contaminant removal or otherwise alter fluid properties of the fluid to improve a user's overall showering experience.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the application as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the apparatus and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A spray head assembly comprising:
an inlet assembly configured to receive a fluid;
a body fluidly coupled with the inlet assembly;
a head portion fluidly removably coupled with the body, the head portion including a plurality of nozzles configured to discharge the fluid from the spray head assembly, the body and the head portion together defining an interior chamber; and
a filter assembly configured to filter the fluid supplied from the inlet assembly to the head portion, the filter assembly configured to be received within the interior chamber.

2. The spray head assembly of claim 1, further comprising a filter housing configured to be received in the interior chamber, the filter housing including a first sidewall and a second sidewall defining a filter chamber, the first sidewall configured to couple with the body, and the second sidewall configured to couple with the head portion.

3. The spray head assembly of claim 2, wherein the filter assembly is configured to be received within the filter chamber, and wherein, when the body and the head portion are separated, the second sidewall remains coupled with the head portion and the first sidewall remains coupled with the body, thereby facilitating access to the filter chamber to replace the filter assembly.

4. The spray head assembly of claim 2, wherein the filter housing includes a top wall configured to couple the first sidewall with the body.

5. The spray head assembly of claim 4, wherein the body includes a connector flange extending within the interior chamber and configured to couple to the top wall.

6. The spray head assembly of claim 5, wherein the first sidewall is configured to engage with an upper surface of the top wall and an exterior facing radial surface of the connector flange.

7. The spray head assembly of claim 2, wherein the inlet assembly includes a ball joint configured to permit selective movement of the body relative to the inlet assembly.

8. The spray head assembly of claim 7, further comprising a compressible member disposed between the ball joint and the filter housing and configured to induce friction between the ball joint and the filter housing to retain a position of the body relative to the inlet assembly.

9. The spray head assembly of claim 2, wherein when the body and the head portion are coupled together, the first sidewall overlaps at least a portion of the second sidewall.

10. The spray head assembly of claim 2, wherein the second sidewall includes a shoulder configured to engage with the filter assembly to support the filter assembly within the filter chamber.

11. The spray head assembly of claim 1, wherein the spray head assembly is configurable both as (i) a first spray head assembly including the body and the head portion defining a first shape configured to receive the filter assembly and (ii) a second spray head assembly including the body and the head portion defining a second shape different than the first shape configured to receive the filter assembly.

12. The spray head assembly of claim 2, further comprising at least one channel disposed between the second sidewall and a spray face of the head portion, the at least one channel configured to supply the fluid to the plurality of nozzles.

13. The spray head assembly of claim 12, wherein the fluid filtered by the filter assembly is supplied directly to the at least one channel.

14. The spray head assembly of claim 1, further comprising a locking system configured to selectively couple the body with the head portion.

15. The spray head assembly of claim 14, wherein the locking system includes an engagement feature along the body or the head portion and a guide along the other one of the body or the head portion and configured to receive the engagement feature.

16. The spray head assembly of claim 1, wherein the body includes a first portion and a second portion movable relative to the first portion, and wherein the second portion includes an indicator indicative of when an action should be carried out by a user based on a position of the second portion relative to the first portion.

17. A spray head assembly comprising:
an inlet assembly configured to receive a fluid;
a body fluidly coupled with the inlet assembly;
a head portion fluidly removably coupled with the body, the head portion including a plurality of nozzles configured to discharge the fluid from the spray head assembly, the body and the head portion defining an interior chamber;
a filter housing defining a filter chamber and configured to be received within the interior chamber; and
a filter assembly configured to filter the fluid supplied from the inlet assembly to the head portion, the filter assembly configured to be received within the filter chamber,
wherein the spray head assembly is configurable both as (i) a first spray head assembly including the body and the head portion defining a first shape configured to receive the filter housing and (ii) a second spray head assembly including the body and the head portion defining a second shape configured to receive the filter housing, and
wherein the second shape is different than the first shape.

18. The spray head assembly of claim 17, wherein, when the body and the head portion are separated, a first portion of the filter housing remains coupled with the head portion and a second portion of the filter housing remains coupled with the body, thereby facilitating access to the filter chamber to replace the filter assembly.

19. A spray head assembly comprising:
an inlet assembly configured to receive a fluid;
a body fluidly coupled with the inlet assembly, the body including a connector flange;
a head portion fluidly coupled with the body, the head portion including a plurality of nozzles configured to discharge the fluid from the spray head assembly;
a filter housing defining a filter chamber, the filter housing including:
a first sidewall;
a top wall configured to couple to the connector flange to couple the first sidewall with the body; and
a second sidewall configured to couple to the head portion and overlap with at least a portion of the first sidewall; and
a filter assembly configured to filter the fluid supplied from the inlet assembly to the head portion, the filter assembly configured to be received within the filter chamber of the filter housing.

20. The spray head assembly of claim 19, wherein the body and the head portion are configured to selectively couple with each other, and wherein, when the body and the head portion are separated, the second sidewall remains coupled with the head portion and the first sidewall and the top wall remain coupled with the body, thereby facilitating access to the filter chamber to replace the filter assembly.
